(19) United States
(12) Patent Application Publication
(10) Pub. No.: US 2006/0240867 A1
(43) Pub. Date: Oct. 26, 2006

(54) MOBILE PHONE WITH MONITORING FUNCTIONS, MONITORING SYSTEM AND MONITORING METHOD THEREOF

(76) Inventors: Kuang-Chih Wang, Hsinchu Hsien (TW); Chih-Hsin Hsu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/161,927

(22) Filed: Aug. 23, 2005

(30) Foreign Application Priority Data
Apr. 26, 2005 (TW) 94113199

(51) Int. Cl. H04M 1/00

(52) U.S. Cl. 455/556.1; 455/550.1

(57) ABSTRACT

A mobile phone with monitoring functions, a monitoring system and a monitoring method thereof are disclosed. The mobile phone monitoring system includes at least a mobile phone, a monitoring unit, a control unit and a predetermined abnormality reaction unit. The mobile phone serves as the mainbody of the monitoring system. The monitoring unit is used for capturing the signal data of a specified area. The control unit is used for generating a triggering signal in response to an abnormal situation. The predetermined abnormality reaction unit is used for generating a preset abnormal signal. The mobile phone monitoring system combines the mobility of a mobile phone with the monitor abnormality reaction of a monitoring system to substantially enhance the capability and feasibility of monitoring tasks.

### CROSS-REFERENCE TO RELATED APPLICATION

This application claims the priority benefit of Taiwan application serial no. 94113199, filed on Apr. 26, 2005. All disclosure of the Taiwan application is incorporated herein by reference.

### BACKGROUND OF THE INVENTION

1. Field of Invention

The present invention relates to a mobile phone and a monitoring method, and particularly to a mobile phone with monitoring functions and a monitoring system and a monitoring method thereof.

2. Description of the Related Art

In the modern life with telecommunication services, mobile phones are indispensable devices for communications. Thanks to the popularity and convenience of the mobile phones, many novel functions are introduced, such as regular calls, cameras, sound recorders and wireless transmission are all integrated in a small-size mobile phone.

In a conventional monitoring system, a computer system is usually required for analyzing, comparing and storing data, as well as for trigging predetermined actions. However, the relevant facilities of the computer system are not mobile enough to be set up at a desired area or time for monitoring tasks. Therefore, the monitoring capability of the conventional monitoring systems is limited.

### SUMMARY OF THE INVENTION

The present invention combines the convenience of mobile phones with a monitoring system to take advantage of the available functions of mobile phones to overcome the inconvenience of the conventional monitoring system and further make the monitoring system more convenient. In other words, the present invention is to develop a monitoring system in mobile phones.

A monitoring system of mobile phones provided by the present invention includes at least a mobile phone and an abnormality reaction unit. The mobile phone includes a monitoring unit, a storage unit and a control unit. The monitoring unit performs a monitoring task according to a signal type and a specified area to be monitored. The storage unit is used for receiving the signal data captured by the monitoring unit and storing the data. The control unit is used for sending out an alert message of abnormal condition if the monitored area is beyond a predetermined condition. The abnormality reaction unit performs an abnormality reaction procedure when receiving an alert message of abnormal condition.

In the above-described monitoring system of mobile phones, if the signal to be monitored by the monitoring unit is an image, the monitoring unit can be a built-in or a plug-in image acquisition unit of the mobile phone. Moreover, the monitoring unit can utilize infrared light to accommodate variations of the environment to be monitored. In an embodiment, a passive infrared light is used to accommodate an environment with insufficient light. In another embodiment, an active infrared light is used to accommodate a dark environment. The active infrared light irradiates on a monitored object, and is then reflected into the lens for imaging such that the monitoring unit captures the image in the dark.

In the above-described monitoring system of mobile phones, if the signal to be monitored by the monitoring unit is a sound, the monitoring unit can be a built-in or a plug-in microphone in a mobile phone.

The above-described monitoring system of mobile phones further includes a power supply device for providing an electric power for the monitoring system.

A mobile phone, provided by the present invention for a monitoring system of mobile phones, includes a monitoring unit, a storage unit and a control unit. The monitoring unit performs a monitoring task according to a signal type and a specified area to be monitored. The storage unit is used for receiving the signal data captured by the monitoring unit and storing the data. The control unit is used for sending out an alert message of an abnormal condition when the monitored area is beyond a predetermined condition. According to the alert message of the abnormal condition, an abnormality reaction procedure is performed.

The above-described mobile phone may include an abnormality reaction unit for receiving an alert message of abnormal condition and then performing an abnormality reaction procedure.

In the above-described mobile phone, if the signal to be monitored by the monitoring unit is an image, the monitoring unit can be a built-in or a plug-in image acquisition unit of the mobile phone. Moreover, the monitoring unit can utilize infrared light to accommodate an environment variation to be monitored. In an embodiment, a passive infrared light is used to accommodate an environment of insufficient light. In another embodiment, an active infrared light is used to accommodate a dark environment. The active infrared light irradiates on a monitored object, and then reflected into a lens for imaging such that the monitoring unit captures the image in the dark.

In the above-described mobile phone, if the signal to be monitored by the monitoring unit is a sound, the monitoring unit can be a built-in or a plug-in microphone.

In a monitoring method provided by the present invention, first, an image acquisition unit of a mobile phone periodically captures an image in a predetermined area in a specific time frame. Then, the captured images of the predetermined area are compared with the images before a specific time frame. If a predetermined condition is not met, an alert message of an abnormal condition would be sent out for an abnormality reaction procedure.

In the above-described monitoring method of an embodiment, the predetermined condition for comparing the difference between an image of the predetermined area and an image before a specific time frame includes a preset value. If a difference between two images is beyond the preset value, the situation is an abnormal condition.

In a monitoring method provided by the present invention, first, a sound acquisition unit of a mobile phone periodically captures a sound in a predetermined area in a specific time frame. Then, the captured sound signals of the predetermined area are compared with the signals before the specific time frame. If a predetermined condition is not met, an alert message of an abnormal condition would be sent out for an abnormality reaction procedure.

In the above-described monitoring method of an embodiment, the predetermined condition for comparing the difference between a sound signal of the predetermined area and a sound signal before a specific time frame includes a preset value. If a difference between two sound signals is beyond the preset value, the situation an abnormal condition.

In the above-described monitoring method of an embodiment, first, an infrared light device of a mobile phone periodically captures environment variations in a predetermined area in a specific time frame. Then, the captured signals of the predetermined area are compared with the signals before a specific time frame. If a predetermined condition is not met, an alert message of an abnormal condition would be sent out for an abnormality reaction procedure.

In the above-described monitoring method of an embodiment, the infrared light of a mobile phone is a passive infrared light to monitor an environment variation of insufficient light.

In the above-described monitoring method of another embodiment, the infrared light of a mobile phone is an active infrared light, which irradiates on an monitored object, then reflected to the lens for imaging such that the monitor unit captures the image in the dark.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a schematic block diagram of a mobile phone monitoring and control system of the present invention.

FIG. 2 is a flowchart of a mobile phone monitoring system for images according to an embodiment of the present invention.

FIG. 3 is a flowchart of a mobile phone monitoring system for sound identification according to another embodiment of the present invention.

### DESCRIPTION OF THE EMBODIMENTS

The present invention combines the conveniences of mobile phones and a monitoring system to take advantage of the available functions of mobile phones to overcome the inconvenience in the conventional monitoring systems. In other words, the present invention is to develop a monitoring system of mobile phones by using the available functions of mobile phones. Such a mobile phone with monitoring functions is able to become a mobile phone monitoring system that can be used at any place and at any specified area. Thus, the mobile phone monitoring system provided by the present invention greatly enhances the monitor capability.

The mobile phone with monitoring functions of the present invention can be optionally configured as a monitor and control system. The mobile phone with monitoring functions, based on the mobility of mobile phones, can be placed at any desired position to be monitored, and performs monitoring tasks according to a selected condition. In an embodiment, a sound volume is used as the evaluation parameter for monitoring environment variations and for an alarm device to send out an alarming signal. In another embodiment, a mobile phone with an image acquisition unit is able to decide whether an abnormal situation occurs or not according to the variation of the captured images, for an alarm device to send out an alarming signal.

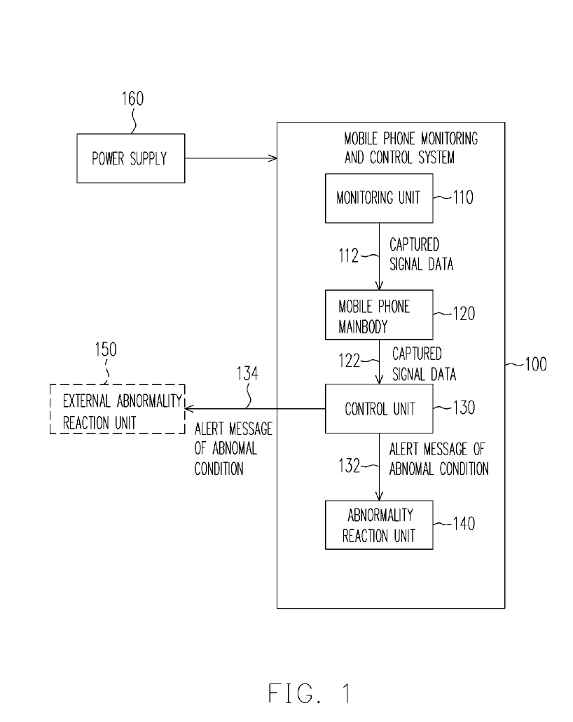

Referring to FIG. 1, it is a schematic block diagram of a mobile phone monitor and control system 100 in an embodiment of the present invention. The mobile phone monitor and control system 100 at least includes a monitoring unit 110, a mobile phone mainbody 120, and a control unit 130. The mobile phone monitor and control system 100 can be integrated into a mobile phone. In an optional embodiment, the predetermined abnormality reaction unit can be either disposed inside the monitoring system marked as 140 unit in FIG. 1 or disposed outside as a plug-in abnormality reaction unit 150 depending on the application requirement.

The monitoring unit 110 is used for selecting the signal data to be monitored. When the target to be captured is sound volume, the monitoring unit 110 can be a sound receiver. When the target to be captured is image data in a specified area, the monitoring unit 110 can be an image acquisition device. The mobile phone mainbody 120 is used for receiving signal data 122 captured by the monitoring unit 110 and then storing the signals. The control unit 130 is connected to the mobile phone mainbody 120 for receiving the stored signal data and analyzing the data to make a decision. If the environment monitored by the mobile phone mainbody 120 is beyond a predetermined condition, for example, the sound volume is beyond a preset value or the captured images show an abnormal variation, an alert message of abnormal condition 132 is accordingly generated based on the predetermined condition and sent to a predetermined abnormality reaction unit 140 or to a plug-in abnormality reaction unit 150.

In the embodiment, the monitoring unit 110, the mobile phone mainbody 120 and the control unit 130 are integrated in a mobile phone, which is explained hereinafter. After turning on a mobile phone monitor and the control system 100, the monitoring unit 110 starts to monitor the function of the specified environment. Then, the monitoring unit 110 sends the captured data to the mobile phone mainbody 120 and stores the captured data, which is then analyzed and compared by the control unit 130. If the result falls within a tolerance range, the control unit 130 would send out a normality signal to the control unit, and proceeds with a data acquisition in the next time frame. On the contrary, if the result falls outside a tolerance range, the control unit 130 would send out an abnormality signal to the built-in predetermined abnormality reaction unit 140 or to a plug-in abnormality reaction unit 150, then trigger an alarm, for example. Note that an independent controller employed in a mobile phone monitoring system is helpful for processing a more sophisticated monitoring system. Such an independent controller employed in a mobile phone monitoring system may process a plurality of predetermined abnormalities or processing a specific abnormality reaction level.

To avoid power limit in a general mobile phone, especially when monitoring a selected object constantly and power might be insufficient, a built-in or plug-in power supply 160 can be included to provide sufficient and continuing power supply to the mobile phone monitor and control system 100.

In the following, other embodiments of the mobile phone monitoring systems of the present invention are discussed.

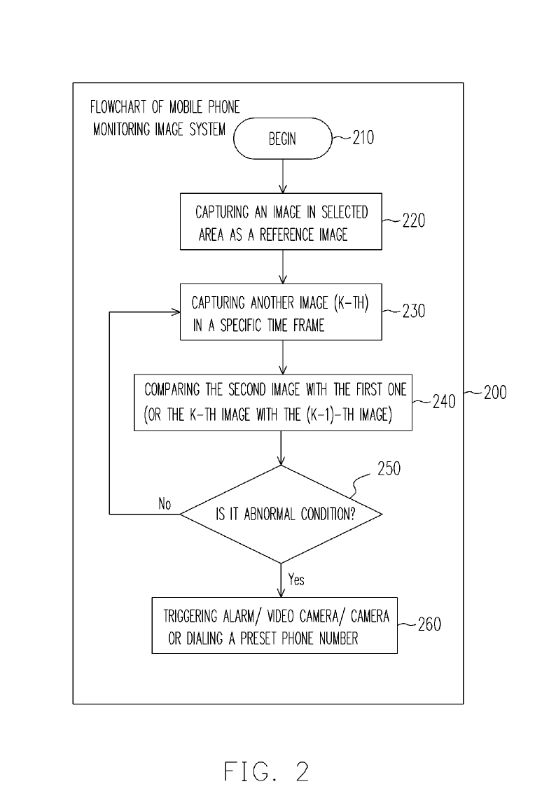

FIG. 2 is a flowchart of a mobile phone monitoring system 200 for images according to an embodiment of the present invention. First, at step 210, the mobile phone and the monitoring unit thereof are turned on. The mobile phone has, for example, a built-in or plug-in camera. Then, at step 220, a first picture is taken as a reference (i.e. a background image) from a selected monitor area. Next, at step 230, the second (or the K-th) picture is taken in every specific time frame. Further, at step 240, the mobile phone stores the image data and compares the first picture with the second picture, or the K-th picture is compared with the (K−1)-th picture. In the step, the system decides the difference of the pictures. If the difference falls within a tolerance range, the system goes on to take the next picture, i.e. the (K+1)-th picture, as in step 230. If the difference is determined to go beyond the tolerance range, an abnormality signal is generated and sent to the abnormality reaction unit. In an embodiment, a difference between the (K+1)-th picture and the picture captured before a time frame is, for example, 20% or 30%, then an abnormality signal is sent out. The predetermined abnormality reaction unit can be an alarm system, a camera, a video recorder, or a phone to alert a user through a preset phone number.

In other words, if the picture difference falls within a tolerance range, then the next image acquisition may go on. On the contrary, if the abnormal condition renders picture difference obvious, the system would react by triggering the alarm, video recorder, camera or phone according to a preset method for protection.

In addition, in the above-described mobile phone monitoring system, the infrared light can be used for monitoring tasks at night or at dark. There are two types of infrared light, a passive infrared light and an active infrared light. The passive infrared light is especially suitable for operations in an environment with insufficient light, but with an additional optical magnifying apparatus or an infrared image sensor. The active infrared light, for example, an infrared LED, would directly irradiate on a monitored object, then is reflected into a lens for imaging. Thus, the images at dark can be captured.

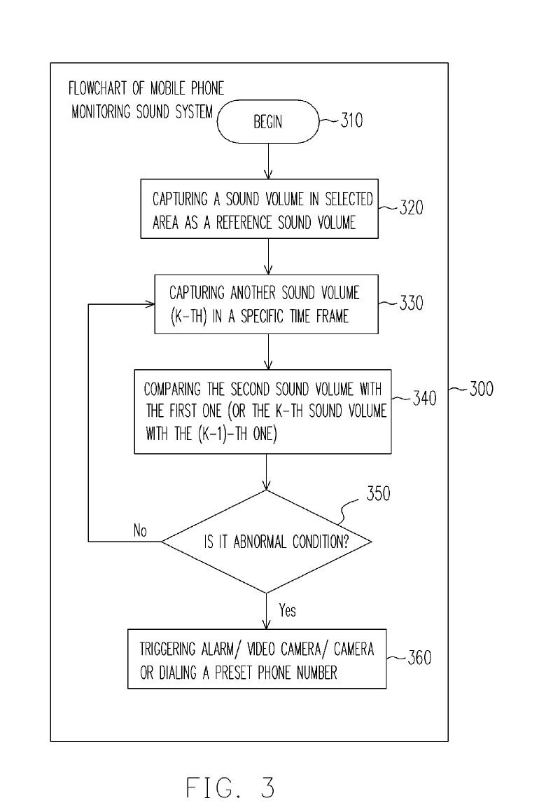

FIG. 3 is a flowchart of a mobile phone monitoring system 300 for sound identification according to another embodiment of the present invention. First, at step 310, the mobile phone and the monitoring unit thereof are turned on. The monitoring unit in the mobile phone can be, for example, a built-in or plug-in microphone, a microphone signal amplifier and a sound recognition circuit. The microphone signal amplifier amplifies the sound signal received by the microphone for deciding whether the sound signal is normal or not.

Then, at step 320, a reference sound volume or a reference frequency spectrum of sound signals, such as background sound volume or a frequency spectrum of sound signals, is obtained from a selected monitor area. The reference sound volume is treated as the first volume. Users may select any area to be monitored. Next, at step 330, the second or the K-th sound volume is taken in every specific time frame. The mobile phone saves the sound signal data, and proceeds with a comparing process between the first volume and the second volume (or comparing the K-th and (K−1)th sound volume) in step 340. In the step, the system decides the difference by comparing the sound volume. If the difference falls within a tolerance range, the system goes on to take the next sound volume, i.e. the (K+1)-th sound volume. If a sound volume difference is beyond the tolerance range, an abnormality signal is generated and sent to the control unit. Once the control unit detects an abnormal situation, it immediately delivers the abnormality signal to a predetermined abnormality reaction unit. The predetermined abnormality reaction unit can be an alarm system, camera, video recorder, or phone to notify the user through the preset number.

In other words, if the sound volume different falls within a tolerance range, a next sound signal acquisition may go on. On the contrary, if the abnormal condition renders the sound volume difference obvious, the system would react by triggering an alarming, video recorder, camera or phone according to a preset method for protection.

Accordingly, the monitoring system for mobile phone in the present invention combines the mobility in the mobile phone and abnormality monitor reaction in the monitoring system, to substantially increase the capability and feasibility of monitoring tasks.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. A mobile phone monitoring system, at least comprising:
a mobile phone, comprising a monitoring unit, a storage unit and a control unit, wherein the monitoring unit is used for performing a monitoring task; the storage unit is used for receiving the signal data captured by the monitoring unit and storing the received signal data; the control unit is connected to the storage unit and used for sending out an alert message of abnormal condition once the monitored area is beyond a predetermined condition; and
an abnormality reaction unit, used for performing an abnormality reaction procedure when receiving the alert message of abnormal condition.

2. The mobile phone monitoring system as recited in claim 1, wherein if the signal type to be monitored by the monitoring unit is an image, the monitoring unit is a built-in image acquisition unit of the mobile phone.

3. The mobile phone monitoring system as recited in claim 1, wherein if the signal type to be monitored by the monitoring unit is an image, the monitoring unit is a plug-in image acquisition unit of the mobile phone.

4. The mobile phone monitoring system as recited in claim 1, wherein if the signal type to be monitored by the monitoring unit is a sound, the monitoring unit is a built-in microphone of the mobile phone.

5. The mobile phone monitoring system as recited in claim 1, wherein if the signal type to be monitored by the monitoring unit is a sound, the monitoring unit is a plug-in microphone of the mobile phone.

6. The mobile phone monitoring system as recited in claim 1, wherein if the signal type to be monitored by the monitoring unit is a sound, the monitoring unit is an additional sound acquisition device.

7. The mobile phone monitoring system as recited in claim 1, further comprising a power supply device for providing the mobile phone monitoring system with a required power.

8. The mobile phone monitoring system as recited in claim 1, wherein the monitoring unit employs an infrared light for accommodating variations of the monitored environment.

9. The mobile phone monitoring system as recited in claim 8, wherein the monitoring unit employs a passive infrared light for accommodating a monitored environment of insufficient light.

10. The mobile phone monitoring system as recited in claim 8, wherein the monitoring unit employs an active infrared light, the active infrared light irradiating the monitored object and being reflected into a lens for imaging to capture the images in a dark environment.

11. A mobile phone suitable for a mobile phone monitoring system, the mobile phone comprising:
a monitoring unit, used for monitoring a signal type and area to be monitored;
a storage unit, used for receiving and storing the signal data captured by the monitoring unit; and
a control unit, connected to the storage unit for sending out an alert message of abnormal condition when the monitored area is beyond a predetermined condition, to proceed with an abnormality reaction procedure through the alert message of abnormal condition.

12. The mobile phone as recited in claim 11, further comprising an abnormality reaction unit used for performing the abnormality reaction procedure when receiving an alert message of abnormal condition.

13. The mobile phone as recited in claim 11, wherein if the signal type to be monitored by the monitoring unit is an image, the monitoring unit is a built-in image acquisition unit of the mobile phone.

14. The mobile phone as recited in claim 11, wherein if the signal type to be monitored by the monitoring unit is an image, the monitoring unit is a plug-in image acquisition unit of the mobile phone.

15. The mobile phone as recited in claim 11, wherein if the signal type to be monitored by the monitoring unit is a sound, the monitoring unit is a built-in microphone of the mobile phone.

16. The mobile phone as recited in claim 11, wherein if the signal type to be monitored by the monitoring unit is a sound, the monitoring unit is a plug-in microphone of the mobile phone.

17. The mobile phone as recited in claim 11, wherein if the signal type to be monitored by the monitoring unit is a sound, the monitoring unit is an additional sound acquisition device.

18. The mobile phone as recited in claim 11, wherein the monitoring unit employs infrared light for accommodating variations of the monitored environment.

19. The mobile phone as recited in claim 18, wherein the monitoring unit uses passive infrared light for accommodating a monitored environment of insufficient light.

20. The mobile phone as recited in claim 18, wherein the monitoring unit employs active infrared light, the active infrared light irradiating the monitored object and being reflected into a lens for imaging to capture the images in a dark environment.

21. A monitoring method, comprising:
using an image acquisition unit of a mobile phone to periodically capture images of an area in every specific time frame;
storing the captured image signal; and
comparing a captured image of the monitored area with the image captured before the specific time frame, wherein an alert message of abnormal condition is sent out for an abnormality procedure when an image difference is beyond a preset condition.

22. The monitoring method as recited in claim 21, wherein the preset condition for comparing the difference between the image captured in the monitored area and the image captured before a specific time frame includes an image difference of more than 20%.

23. A monitoring method, comprising:
using a sound acquisition unit of a mobile phone to periodically capture a sound of an area in every specific time frame;
storing the captured sound signal; and
comparing a captured sound signal of the monitored area with the sound signal captured before a specific time frame, wherein an alert message of abnormal condition is sent out for an abnormality procedure when a sound signal difference is beyond a preset condition.

24. The monitoring method as recited in claim 23, wherein the preset condition for comparing the difference between the sound captured in the monitored area and the sound captured before a specific time frame includes an image difference of more than 20%.

25. A monitoring method, comprising:
using a mobile phone to periodically capture variations of an area in every specific time frame;
storing the captured signal; and
comparing a captured signal of the monitored area with the signal captured before a specific time frame, wherein an alert message of abnormal condition is sent out for an abnormality reaction procedure when a signal difference is beyond a preset condition.

26. The monitoring method as recited in claim 25, wherein the mobile phone uses a passive infrared light for accommodating a monitored environment of insufficient light.

27. The monitoring method as recited in claim 25, wherein the mobile phone uses an active infrared light, the active infrared light irradiating onto a monitored object, and being reflected into a lens for imaging to capture the images in a dark environment.
